(19) United States
(12) Patent Application Publication
(10) Pub. No.: US 2019/0118680 A1
(43) Pub. Date: Apr. 25, 2019

(54) ADVANCED ACTIVE CRASH SEAT SYSTEMS AND METHODS

(71) Applicant: TenCate Advanced Armor USA, Inc., Goleta, CA (US)

(72) Inventor: Erick Sagebiel, Goleta, CA (US)

(73) Assignee: TenCate Advanced Armor USA, Inc., Goleta, CA (US)

(21) Appl. No.: 16/169,015

(22) Filed: Oct. 24, 2018

Related U.S. Application Data
(60) Provisional application No. 62/576,902, filed on Oct. 25, 2017.

(51) Int. Cl. B60N 2/427; B60N 2/50

(52) U.S. Cl. CPC B60N 2/4279; B60N 2/50; B60N 2/42736

(57) ABSTRACT

Described are active crash systems for seats and associated methods. The active crash system includes a seat for an occupant of a vehicle and a crash seat system. The crash seat system includes a seat velocity device and a trigger device. The seat velocity device is configured to selectively move the seat. The trigger device configured to estimate at least one of an impact time or an impact condition of an impact event based on a detectable condition and activate the seat velocity device at an activation time prior to the estimated impact time such that the seat is moved.

### REFERENCE TO RELATED APPLICATION

This application claims the benefit of U.S. Provisional Application No. 62/576,902, filed Oct. 25, 2017 and entitled BOOSTER SEAT, the content of which is hereby incorporated by reference in its entirety.

### FIELD OF THE INVENTION

The field of the invention relates to crash seats for vehicles, and, more particularly, to crash seats that improve occupant safety during an impact event.

### BACKGROUND

Vehicles, such as aircraft, buses, trains, ships, and automobiles, may be subjected to high acceleration pulses and impact forces during various impact events. As used herein, an impact event may refer to an aircraft crash, a car crash, an exploding mine or improvised explosive device, and/or various other events that may impart high acceleration pulses and impact forces on the vehicles. These acceleration pulses and impact forces are usually transmitted to an occupant of the vehicle, and pose the risk of moderate to fatal injury to the occupant. In many cases, the occupant of the vehicle is seated within a seat of the vehicle at the time of the impact event, but the seat offers little to no protection against the impact event (and at best passive energy absorption), and the acceleration pulses and impact forces are at least partially transferred to the occupant through the seat. In view of the limitations of existing seats, there is a need for a seat that provides improved occupant safety during an impact event.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

According to some examples, an active crash system includes a seat for an occupant of a vehicle and a crash seat system. The crash seat system includes a seat velocity device and a trigger device. The seat velocity device is configured to selectively move the seat. The trigger device configured to estimate an impact time of an impact event based on a detectable condition and activate the seat velocity device at an activation time prior to the estimated impact time such that the seat is moved.

According to various examples, a crash seat system for a crash seat includes a seat velocity device configured to selectively move the seat when activated. The crash seat system also includes a trigger device configured to estimate an impact time of an impact event based on a detectable condition and activate the seat velocity device at an activation time prior to the estimated impact time.

According to certain examples, a method of controlling a seat with a crash seat system includes estimating at least one of an impact time or an impact condition for an impact event for the seat using a trigger device of the crash seat system based on a detectable condition. The method includes moving the seat with a seat velocity device at an activation time prior to the estimated impact time. In some aspects, the activation time is based on the estimated impact time or the estimated impact condition.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

FIG. 1 is a diagram of a crash seat system according to aspects of the present invention.

FIG. 2 illustrates a vehicle with an active crash system having the crash seat system of FIG. 1.

FIG. 3 is another view of the vehicle with the active crash system of FIG. 2.

FIG. 4 is another view of the vehicle with the active crash system of FIG. 2.

FIG. 5 is a flowchart of a method of controlling a seat with the active crash system of FIG. 1 according to aspects of the present invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

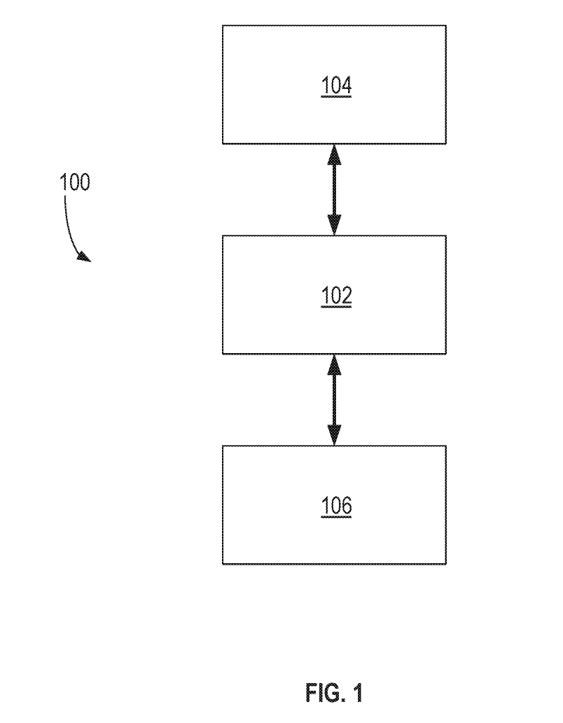

FIG. 1 illustrates an example of a crash seat system 100 according to examples of the present disclosure. The crash seat system 100 includes a trigger device 102, a seat velocity device 104, and a sensor 106. While a single seat velocity device 104 and a single sensor 106 are illustrated, any number of seat velocity devices 104 and/or sensor 106 may be provided as desired.

The seat velocity device 104 is configured to selectively move a seat for an occupant of a vehicle when activated. In some cases, a single seat velocity device 104 may selectively move a plurality of seats when activated. The seat velocity device 104 may be various suitable devices for selectively moving the seat including, but not limited to, a pretensioner that pulls the seat or pushes the seat, an airbag, a rocket, a mass ejector, a biased spring, a spring with a release, combinations thereof, and/or various other suitable devices or mechanisms as desired. In some examples, the seat velocity device 104 is configured to move the seat along a single axis. However, in other examples, the seat velocity device 104 may selectively move the seat along a plurality of axes.

When the seat velocity device 104 is activated, the seat velocity device is configured to move the seat at a predetermined velocity. In some cases, the predetermined velocity may be controlled based on a control factor including, but not limited to, a distance or clearance limit, a lumbar force or g-force limit, an activation time, combinations thereof, or various other suitable control factors. In some examples, the predetermined velocity is about 3 m/s; however, in other examples, the predetermined velocity may be less than 3 m/s or greater than 3 m/s. For example, in one non-limiting example, the predetermined velocity may be from about 1 m/s to about 5 m/s, although in other examples, it may be less than 1 m/s and/or greater than 5 m/s.

The sensor 106 is controlled to measure and detect a condition of the vehicle and/or seat during use. For example, in some cases, the detectable condition may include, but is not limited to, an altitude of the vehicle and/or seat, a direction of movement of the vehicle and/or seat, an orientation of the vehicle and/or seat, a speed or acceleration of the vehicle and/or seat, a proximity of the vehicle and/or seat to another object, a position of the seat, a weight of an occupant and equipment in the seat, head or helmet clearance, combinations thereof, and/or various other suitable detectable conditions. As such, the sensor 106 may be various suitable devices for detecting at least one detectable condition including, but not limited to, a radar detector, a smash surface (such as on a component of the vehicle such as a nose cone, bumper, etc.) an altimeter, a proximity sensor, a load cell, a laser range finder, an accelerometer, an optical device (e.g., a camera or other suitable optical device), combinations thereof, and/or various other suitable sensor devices. In examples where a plurality of sensors 106 are provided, the sensors may all be the same type of sensor, or at least one sensor may be a different type of sensor from another sensor. For example, one sensor 106 may be an altimeter and another sensor 106 may be a proximity sensor. Various other suitable combinations of sensors 106 may be utilized.

The trigger device 102 communicates data with one or more of the seat velocity device 104 and the sensor 106. The data communication may be wireless or wired communication, or combinations thereof.

In some aspects, the trigger device 102 can include one or more processing devices that execute instructions stored on a memory. Executing the instructions can cause the trigger device 102 to predict an impact event, estimate an impact time of the impact event, determine an activation time, and activate the seat velocity device 104, among others, as described in detail below. For instance, the trigger device 102 can compute an estimated impact time based on the condition measurements from the sensor 106 and cause the seat velocity device 104 to move the seat based on the estimated impact time. Causing the seat velocity device 104 to move the seat can include, for example, transmitting one or more control signals to the seat velocity device 104. A control signal can cause the seat velocity device 104 to activate and/or move certain distances, certain speeds, certain directions, etc.

In various aspects, the trigger device 102 can include one or more of a general purpose processing unit, a processor specially designed for impact event analysis and/or crash seat control applications, a processor specially designed for wireless communications (such as a Programmable System On Chip (PSOC) from Cypress Semiconductor or other suitable processors). A memory may be provided with the trigger device 102, although it need not in other examples. The memory may include a long-term storage memory and/or a short-term working memory. The memory may be used by the trigger device 102 to store a working set of processor instructions. The processor may write data to the memory. The memory may include a traditional disk device. In some aspects, the memory could include either a disk based storage device or one of several other type storage mediums to include a memory disk, USB drive, flash drive, remotely connected storage medium, virtual disk drive, or the like.

Various other features including, but not limited to, a communication circuit/unit, an optional display, an optional speaker, and/or power storage unit may also be included in the trigger device 102. In some aspects, some or all of the components of the trigger device 102 may be included together in a single package or sensor suite, such as within the same enclosure. In additional or alternative aspects, some of the components may be included together in an enclosure and the other components may be separate. Thus, the trigger device 102 may be a distributed system. This is merely one example and other configurations may be implemented.

In various aspects, the trigger device 102 communicates data with the sensor 106 such that the trigger device 102 receives a data signal from the sensor 106. In various aspects, the data signal from the sensor 106 includes one or more condition measurements of the vehicle and/or seat during use. As mentioned, the condition measurements may include proximity measurements, altitude measurements, speed or acceleration measurements, direction measurements, etc. In certain examples, the data signal is sent continuously from the sensor 106 to the trigger device 102 (i.e., the data signal is sent as soon as a condition measurement is made by the sensor 106). In other examples, the sensor 106 sends the data signal after a predetermined number of condition measurements have been measured by the sensor 106 (i.e., the data signal is not sent continuously).

The trigger device 102 can analyze the condition measurements from the sensor 106 and predict an impact event. In some aspects, analyzing the condition measurements includes comparing the measured condition with a predefined condition to predict the impact event. In various aspects, analyzing the condition measurements includes predicting an impact event based on a change in the measured condition. For example, analyzing the condition measurements may include predicting the impact event based on a change in altitude, a change in proximity, a change in direction, a change in acceleration or speed, combinations thereof, and various other changes in the measured condition. In various cases, predicting the impact event may include predicting an impact direction of the impact event.

In some cases, predicting the impact event includes estimating an impact time (i.e., an amount of time until the impact event occurs) of the impact event based on the analyzed measured conditions. For example, in some cases, the impact time may be estimated based on a change in altitude, a change in proximity, a change in direction, a change in acceleration or speed, combinations thereof, and various other changes in the measured condition. In various cases, the trigger device 102 can also determine an activation time, which is a predetermined amount of time prior to the estimated impact time. In some examples, the activation time corresponds to an amount of time before there is relative motion of the floor or crash wall. In certain cases, the activation time may be controlled based on a control factor including, but not limited to, the predetermined velocity of the seat velocity device 104, a movement distance and/or clearance limit of the seat, a lumbar force or g-force limit, the estimated impact event, the type of impact event, combinations thereof, a desired event time length, or various other suitable control factors.

In various examples, the trigger device 102 communicates the control signal to the seat velocity device 104. The control signal causes the seat velocity device 104 to be activated and to move the seat at the activation time. Causing the seat velocity device 104 to be activated may include, but is not limited to, activating an airbag, activating a rocket, activating the pretensioner to push or pull the seat, releasing a spring, ejecting a mass, activating a motor, combinations thereof, or various other suitable activations. Causing the seat to move may include, but is not limited to, moving the seat certain distances, certain angular positions, certain speeds, certain directions, at certain lumbar or g-forces, etc.

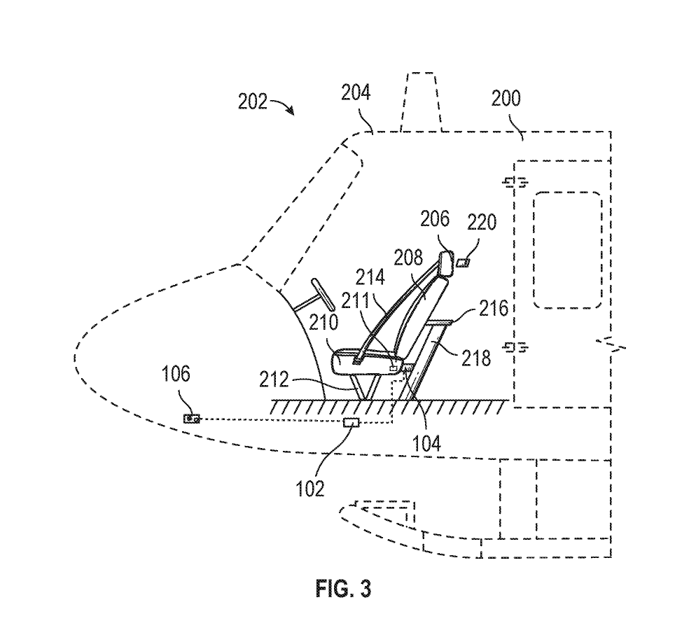

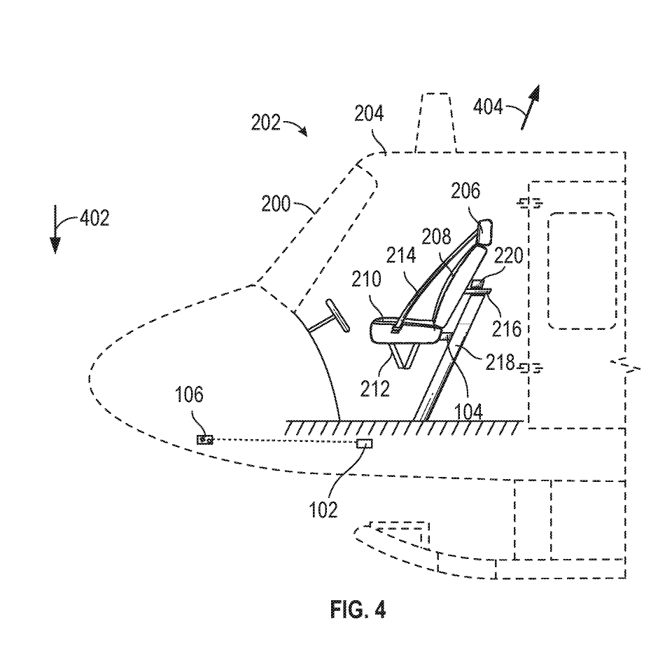

Optionally, the crash seat system 100 may also include a motion device (see, e.g., FIGS. 3 and 4), which may include an energy-absorbing (EA) mechanism. In various aspects, the motion device may limit free movement to a single direction (e.g., is a “one-way” motion device), and may resist movement and/or impede movement in an opposite direction by providing an absorbing or resisting force against movement in the opposite direction. In other examples, the motion device may allow for movement in a plurality of directions. Optionally, the motion device may allow the seat to be reset as desired. The EA mechanism may be an active or passive mechanism including, but not limited to, wedge catches, locking straps, a cylinder (hydraulic or pneumatic), an energy absorbing structural member (such as a rubber component, a metallic component, or a composite component), or a metal or composite structure arranged to deflect or bend when subjected to a predetermined load. In various aspects, the EA mechanism of the motion device optionally absorbs energy (such as that associated with an impact) by, among other things, deflection, torsion, or compression. In various examples, the motion device may allow for the seat to potentially move unimpeded during the initial activation such that the correct (i.e., desired) speed is imparted onto the seat by the seat velocity device. In various aspects, after the initial activation, the motion device may “catch” or “lock in” with the seat such that movement in a particular direction is impeded (e.g., because the motion device provides the absorbing or resisting force to movement in the particular direction). For example, the motion device may allow for unimpeded movement in an upwards direction, and may further lock in or catch the seat to impede movement in a downwards direction. In various aspects, the initial movement of the seat lengthens the seat stroke, which allows the motion device to absorb the energy over a longer distance. In some cases, the motion device may catch or lock in with the seat based on various parameters including, but not limited to, a predetermined amount of time after initial activation, at the impact event time, a distance traveled by the seat, a type of crash event, etc.

As one example of the motion device in use, the motion device may allow the seat to move unimpeded during the initial activation such that the correct speed is imparted onto the seat. Once the vehicle begins the impact event and a speed differential occurs, the motion device can catch seat such that the seat can take full advantage of the new stroke (e.g., longer stroke) and utilize the motion device to absorb the rest of the energy.

In some cases, the crash seat system 100 may further optionally include a distance-limiting device (see, e.g., FIGS. 3 and 4). In various examples, the distance-limiting device may define a maximum movement length or distance that the seat velocity device 104 can move the seat when activated.

By intentionally moving the seat prior to the impact event (i.e., at the activation time with the seat velocity device 104), the crash seat system 100 may reduce the velocity differential of the impact event. Reducing the velocity differential may reduce or minimize the acceleration pulses and impact forces of the impact event, and thereby reduce the risk of moderate to fatal injury to the occupant during the impact event. The crash seat system 100 also may move the seat in a direction opposite from the direction of the impact event, which may further maximize the reduction in velocity differential and move the occupant away from the impending crash surface. The crash seat system 100 may further lengthen the overall event time of the impact event by moving the seat prior to the impact event, which provides more time to reduce or minimize potential injury to the occupant. Intentionally moving the seat prior to the impact event also increases the potential stroke for the one-way, EA mechanism to work, allowing for a larger crash duration and/or further reducing the load on the occupant. In some cases, the crash seat system 100 moves the seat such that during the impact event, the occupant's body maintains intimate contact with the seat and is not given free potion to potentially create a second impact between the occupant and the seat.

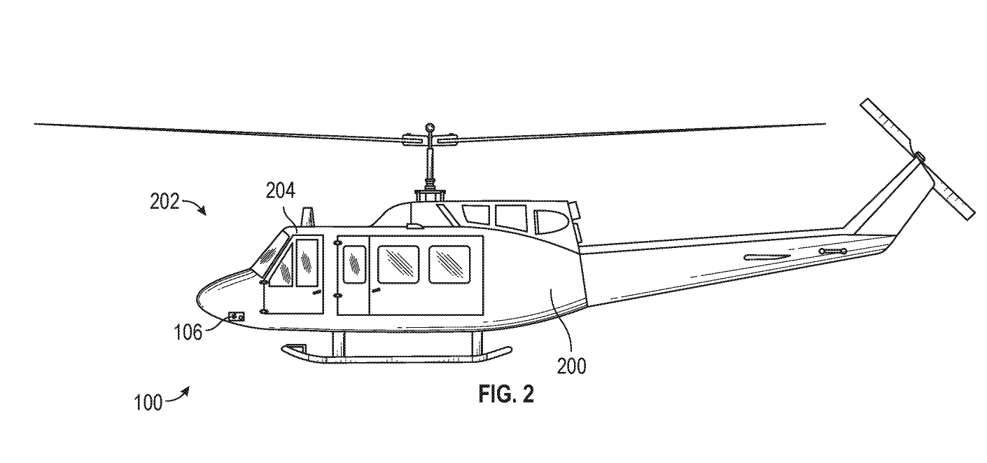

FIGS. 2-4 illustrate an example of a vehicle 200 with an active crash system 202 that includes the crash seat system 100. In the example of FIGS. 2-4, the vehicle 200 is a helicopter. However, in other examples, the active crash system 202 and/or the crash seat system 100 may be provided with various other types of vehicles as desired including, but not limited to, armored vehicles, trucks, cars, race car, buses, other types of aircraft, trains, tanks, etc. As such, the disclosure of the helicopter should not be considered limiting on the current disclosure.

In some cases, the vehicle 200 includes a cab 204. As best illustrated in FIGS. 3 and 4, a seat 206 of the active crash system 202 is optionally provided within the cab 204. However, in other examples, the seat 206 may be provided at various other locations on the vehicle 200 as desired. The seat 206 generally includes a seat base 210 and a seat back 208. Optionally, the seat back 208 is movable relative to the seat base 210 such that the seat back 208 can be tilted forward or aft relative to the seat base 210. In some optional examples, the crash seat system 100 includes a seat back controller 211 that controls the position of the seat back 208 relative to the base. In various aspects, the seat back controller 211 is communicatively coupled with the trigger device 102 such that the seat back controller 211 selectively positions the seat back 208 based on the impact event. As one non-limiting example, the seat back controller 211 may be activated prior to, at the same time, or after the activation of the seat velocity device 104 such that the seat back 208 is reclined. In such examples, the seat back controller 211 may position the occupant's spine in a predetermined position (e.g., by reclining or tilting the seat forward) based on the expected g-force, etc.

A leg assembly 212 or other suitable support may be provided to support the seat 206. In the example of FIGS. 3 and 4, the seat 206 is a pilot's seat; however, in other examples, the seat 206 may be various other suitable types of seats as desired. Optionally, the seat 206 includes a seat belt 214. When provided, the seat belt 214 may optionally be pre-tensioned, meaning that the seat belt 214 locks or maintains its position when subjected to a large enough force.

In some optional examples, the seat 206 includes a projection 216. During activation of the seat velocity device 104, the seat velocity device 104 may act against or exert a force on the projection 216 to give velocity to the seat 206. The projection 216 may be provided at various locations as desired when included. In other examples, the projection 216 may be omitted, and the seat velocity device 104 may act directly on the seat base 210, seat back 208, or other suitable location. In addition, depending on the type of seat velocity device 104 utilized, various other components or features may be provided with the seat 206 to provide an interface between the seat 206 and the seat velocity device 104. For example, optionally the seat 206 may include hooks, pins, loops, bolts, straps, combinations thereof, or various other suitable mechanisms providing an interface between the seat 206 and the seat velocity device 104.

In the example of FIGS. 2-4, the sensor 106 of the crash seat system 100 is an optical sensor provided on the exterior of the vehicle 200. As mentioned, in other examples, the sensor 106 may be various other suitable types of sensors as desired. In addition, the location of the sensor 106 on the vehicle should not be considered limiting on the current disclosure, as the sensor 106 may be provided at various locations as desired, and need not be provided on the exterior of the vehicle 200. The seat velocity device 104 in the example of FIGS. 2-4 is a mass ejector that moves the seat. In other examples, the seat velocity device may be a pretensioner that pulls the seat or pushes the seat, an airbag, a rocket, a biased spring, a spring with a release, combinations thereof, and/or various other suitable devices or mechanisms as desired.

As best illustrated in FIGS. 3 and 4, in addition to the trigger device 102, seat velocity device 104, and sensor 106, the crash seat system 100 includes a motion device 218 and a distance-limiting device 220. In this example, the motion device 218 includes an EA mechanism that is an energy-absorbing cylinder. In some examples, the motion device 218 is a one-way motion device, although it need not be in other examples. In certain cases, the motion device allows for initial unimpeded movement of the seat by the seat velocity device 104. As described in detail below, after the initial activation (e.g., after the seat has traveled a certain distance, at the impact event time, at a predetermined amount of time after the activation time, etc.), the EA mechanism is activated to absorb energy as the seat moves in a particular direction. In the example of FIGS. 3 and 4, the distance-limiting device 220 is a bar that selectively engages the projection 216 (or other suitable portion of the seat 206) to limit the upward stroke of the seat 206. Various other suitable types of distance-limiting devices 220 may be utilized. In some cases, the distance-limiting device 220 defines a maximum movement distance of the seat 206 when it is moved by the seat velocity device 104, although it need not in other examples. In some examples, the maximum movement distance is at least 2 inches. However, in other examples, the maximum movement distance may be less than 2 inches and/or greater than 2 inches. In other examples, the maximum movement distance may be an amount of clearance between the seat 206 and the closest wall or other structure.

FIG. 3 illustrates the vehicle 200 and active crash system 202 in a normal operating condition where no impact event has been detected or predicted by the crash seat system 100. By comparison, FIG. 4 illustrates the vehicle 200 and active crash system 202 just before the impact event occurs in the direction indicated by the arrow 402. In FIG. 4, the crash system 100 has activated the seat velocity device 104 and started to move the seat 206 in the direction indicated by the arrow 404 to reduce the velocity differential when the impact event occurs and/or to lengthen the event time of the impact event (i.e., the event has already begun by movement of the seat even though the impact event has not yet occurred). In the example illustrated in FIG. 4, because the impact event has not yet occurred, the motion device 218 may not yet be activated and/or locked in with the seat 206. In some cases, once the impact event begins, the motion device 218 is activated and/or locked in to absorb energy as the seat moves in a direction other than the direction indicated by the arrow 404. For example, the motion device 218 may absorb energy as the seat is moved in a direction opposite from the direction indicated by the arrow 404.

In various examples, the crash seat system 100 may reduce the change in velocity and force of the impact event even if the seat velocity device 104 does not activate due to failure, because it is turned off, or for other various reasons. In particular, the motion device 218 will still absorb energy and/or impede movement in the direction of the crash to reduce the effects of the impact event. In such a case, the seat stroke may be shorter compared to the seat stroke when the seat velocity device 104 is activated.

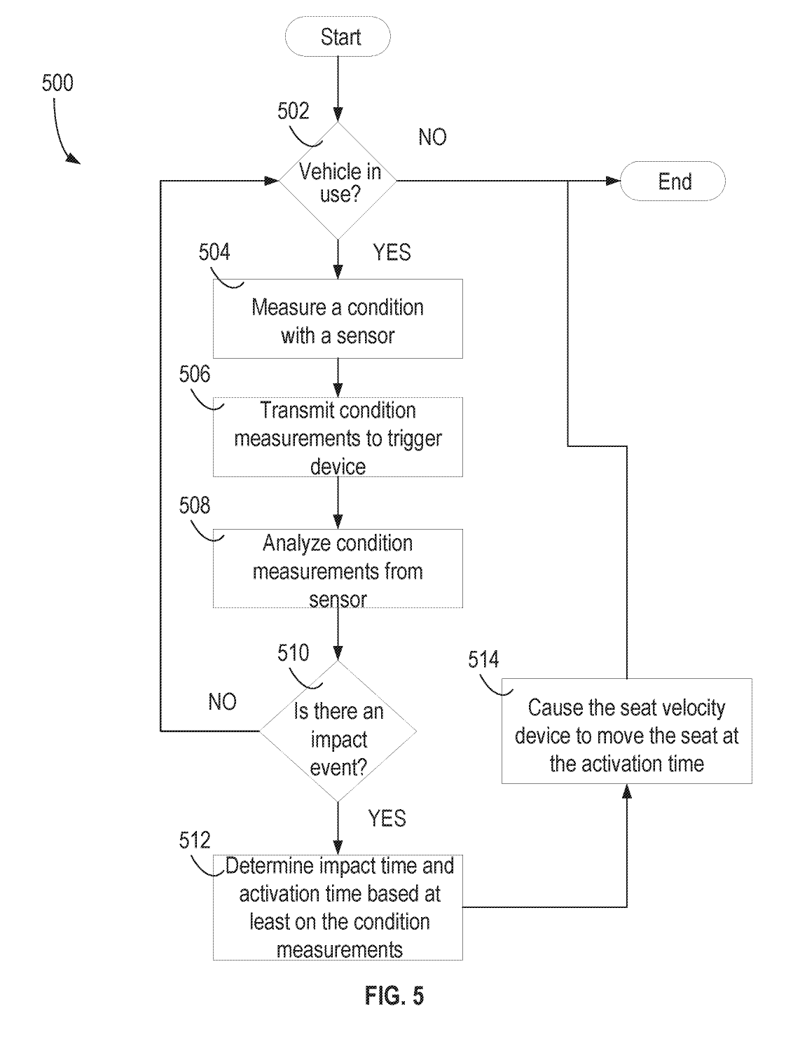

FIG. 5 depicts an example of a method 500 of controlling a seat using the crash seat system 100. Method 500 is described with respect to one or more examples provided herein. However, other implementations are possible.

In a block 502, the method includes determining whether the vehicle that includes the seat is in use. Optionally, if the vehicle is not in use, the method ends. In some cases, block 502 optionally includes determining whether the crash seat system 100 is activated. For example, in some cases, the crash seat system 100 may be manually or selectively turned on or off (e.g., through a switch or other suitable device) by a user of the system. In various aspects, if the crash seat system 100 is deactivated, the method ends.

In a block 504, the method includes measuring a detectable condition with the sensor 106 of the crash seat system 100. In some cases, the detectable condition is optionally provided to the system by a user through a user interface device. In some examples, measuring the detectable condition includes measuring at least one of an altitude of the vehicle and/or seat, a direction of movement of the vehicle and/or seat, a position of the seat, a weight of an occupant and equipment in the seat, head or helmet clearance, an orientation of the vehicle and/or seat, a speed or acceleration of the vehicle and/or seat, a proximity of the vehicle and/or seat to another object, combinations thereof, and/or various other suitable detectable conditions.

In a block 506, the sensor 106 transmits the condition measurements to the trigger device 102 as a data signal. The sensor 106 transmits the condition measurements continuously or at intervals (which may be transmitted during or after the condition measuring by the sensor 106).

In a block 508, the trigger device 102 analyzes the condition measurements from the sensor 106. In some aspects, analyzing the condition measurements includes comparing the measured condition with a predefined condition. In various aspects, analyzing the condition measurements includes comparing a change in the measured condition with a predefined change in the condition indicative of an impact event.

In a block 510, if the condition measurements do not indicate an impact event, the process returns to block 502.

In a block 512, if the condition measurements indicate an impact event, the trigger device 102 determines an estimated impact time of the impact event based on the condition measurements. The trigger device 102 may also determine an activation time a predetermined amount of time prior to the estimated impact time for the activation of the seat velocity device 104. In certain cases, determining the impact time and/or the activation time is based on a control factor including, but not limited to, the predetermined velocity of the seat velocity device 104, a movement distance and/or clearance limit of the seat, a lumbar force or g-force limit, the estimated impact event, the type of impact event, combinations thereof, a desired event time length, or various other suitable control factors. In various examples, the activation time is at least 40 ms prior to the estimated impact time. However, in other examples, the activation time may be less than 40 ms or greater than 40 ms.

In a block 514, the trigger device 102 sends a control signal to the seat velocity device 104. The control signal causes the seat velocity device 104 to be activated and to move the seat at the activation time. Activating the seat velocity device 104 may include, but is not limited to, activating an airbag, activating a rocket, activating the pretensioner to push or pull the seat, releasing a spring, ejecting a mass, activating a motor, combinations thereof, or various other suitable activations. Moving the seat may include, but is not limited to, moving the seat certain distances, certain angular positions, certain speeds, certain directions, at certain lumbar or g-forces, etc.

A collection of exemplary embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the invention is not limited to these example embodiments but rather encompasses all possible modifications and variations within the scope of the issued claims and their equivalents.

EC 1. An active crash system comprising: a seat for an occupant of a vehicle; and a crash seat system comprising a seat velocity device and a trigger device, wherein the seat velocity device is configured to selectively move the seat, and wherein the trigger device configured to estimate an impact time of an impact event based on a detectable condition and activate the seat velocity device at an activation time prior to the estimated impact time such that the seat is moved.

EC 2. The active crash system of any of the preceding or subsequent example combinations, wherein the seat velocity device is configured to move the seat at a predetermined velocity for a predetermined distance when activated.

EC 3. The active crash system of any of the preceding or subsequent example combinations, wherein the trigger device is configured to determine the activation time based on at least one of the predetermined velocity and the predetermined distance.

EC 4. The active crash system of any of the preceding or subsequent example combinations, further comprising a motion device configured to selectively engage the seat after the activation time.

EC 5. The active crash system of any of the preceding or subsequent example combinations, wherein the motion device comprises an energy-absorbing device that impedes movement in at least one direction.

EC 6. The active crash system of any of the preceding or subsequent example combinations, wherein the crash seat system further comprises a distancing limiting device that defines a maximum movement distance of the seat when the seat velocity device is activated and the seat is moved.

EC 7. The active crash system of any of the preceding or subsequent example combinations, wherein the trigger device comprises a sensor and a controller, wherein the sensor is configured to detect the detectable condition, and wherein the sensor comprises at least one of an altimeter, a proximity device, an accelerometer, an optical device, and a radar detector.

EC 8. The active crash system of any of the preceding or subsequent example combinations, wherein the seat velocity device comprises at least one of an airbag, a rocket, a pretensioner, a mass ejector, and a spring.

EC 9. The active crash system of any of the preceding or subsequent example combinations, wherein the trigger device is further configured to estimate an impact direction of the impact event, and wherein the trigger device is configured to activate the seat velocity device at the activation time such that the seat is moved in a direction opposite from the impact direction.

EC 10. A crash seat system for a crash seat, the crash seat system comprising: a seat velocity device configured to selectively move the seat when activated; and a trigger device configured to estimate an impact time of an impact event based on a detectable condition and activate the seat velocity device at an activation time prior to the estimated impact time.

EC 11. The crash seat system of any of the preceding or subsequent example combinations, wherein the trigger device comprises a sensor and a controller, wherein the sensor is configured to detect the detectable condition, and wherein the sensor comprises at least one of an altimeter, a proximity sensor, an accelerometer, an optical device, and a radar detector.

EC 12. The crash seat system of any of the preceding or subsequent example combinations, wherein the trigger device is configured to determine the activation time based on at least one of a movement distance, the estimated impact time, and a movement velocity of the seat when moved by the seat velocity device.

EC 13. The crash seat system of any of the preceding or subsequent example combinations, further comprising a motion device configured to selectively engage the seat after the activation time.

EC 14. The crash seat system of any of the preceding or subsequent example combinations, wherein the seat velocity device comprises at least one of an airbag, a rocket, a pretensioner, a mass ejector, and a spring.

EC 15. The crash seat system of any of the preceding or subsequent example combinations, further comprising a distancing limiting device that defines a maximum movement distance of the seat when the seat velocity device is activated.

EC 16. A method of controlling a seat with a crash seat system, the method comprising: estimating at least one of an impact time or an impact condition for an impact event for the seat using a trigger device of the crash seat system based on a detectable condition; and moving the seat with a seat velocity device at an activation time prior to the estimated impact time, wherein the activation time is based on the estimated impact time or the estimated impact condition.

EC 17. The method of any of the preceding or subsequent example combinations, wherein moving the seat comprises moving the seat at a predetermined velocity for a predetermined distance.

EC 18. The method of any of the preceding or subsequent example combinations, wherein the seat velocity device comprises at least one of an airbag, a rocket, a pretensioner, a mass ejector, and a spring.

EC 19. The method of any of the preceding or subsequent example combinations, wherein moving the seat comprises moving the seat in a first direction, wherein the method further comprises engaging a motion device with the seat at the predetermined distance, and wherein the motion device provides an resisting force against movement of the seat in a second direction that is opposite from the first direction.

EC 20. The method of any of the preceding or subsequent example combinations, wherein estimating the impact condition includes estimating an impact direction of the impact event, and wherein moving the seat comprising moving the seat in a direction opposite from the impact direction.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

That which is claimed is:

1. An active crash system comprising:
a seat for an occupant of a vehicle; and
a crash seat system comprising a seat velocity device and a trigger device, wherein the seat velocity device is configured to selectively move the seat, and wherein the trigger device configured to estimate an impact time of an impact event based on a detectable condition and activate the seat velocity device at an activation time prior to the estimated impact time such that the seat is moved.

2. The active crash system of claim 1, wherein the seat velocity device is configured to move the seat at a predetermined velocity for a predetermined distance when activated.

3. The active crash system of claim 2, wherein the trigger device is configured to determine the activation time based on at least one of the predetermined velocity and the predetermined distance.

4. The active crash system of claim 1, further comprising a motion device configured to selectively engage the seat after the activation time.

5. The active crash system of claim 4, wherein the motion device comprises an energy-absorbing device that impedes movement in at least one direction.

6. The active crash system of claim 1, wherein the crash seat system further comprises a distancing limiting device that defines a maximum movement distance of the seat when the seat velocity device is activated and the seat is moved.

7. The active crash system of claim 1, wherein the trigger device comprises a sensor and a controller, wherein the sensor is configured to detect the detectable condition, and wherein the sensor comprises at least one of an altimeter, a proximity device, an accelerometer, an optical device, and a radar detector.

8. The active crash system of claim 1, wherein the seat velocity device comprises at least one of an airbag, a rocket, a pretensioner, a mass ejector, and a spring.

9. The active crash system of claim 1, wherein the trigger device is further configured to estimate an impact direction of the impact event, and wherein the trigger device is configured to activate the seat velocity device at the activation time such that the seat is moved in a direction opposite from the impact direction.

10. A crash seat system for a crash seat, the crash seat system comprising:
a seat velocity device configured to selectively move the seat when activated; and
a trigger device configured to estimate an impact time of an impact event based on a detectable condition and activate the seat velocity device at an activation time prior to the estimated impact time.

11. The crash seat system of claim 10, wherein the trigger device comprises a sensor and a controller, wherein the sensor is configured to detect the detectable condition, and wherein the sensor comprises at least one of an altimeter, a proximity sensor, an accelerometer, an optical device, and a radar detector.

12. The crash seat system of claim 10, wherein the trigger device is configured to determine the activation time based on at least one of a movement distance, the estimated impact time, and a movement velocity of the seat when moved by the seat velocity device.

13. The crash seat system of claim 10, further comprising a motion device configured to selectively engage the seat after the activation time.

14. The crash seat system of claim 10, wherein the seat velocity device comprises at least one of an airbag, a rocket, a pretensioner, a mass ejector, and a spring.

15. The crash seat system of claim 10, further comprising a distancing limiting device that defines a maximum movement distance of the seat when the seat velocity device is activated.

16. A method of controlling a seat with a crash seat system, the method comprising:
estimating at least one of an impact time or an impact condition for an impact event for the seat using a trigger device of the crash seat system based on a detectable condition; and
moving the seat with a seat velocity device at an activation time prior to the estimated impact time, wherein the activation time is based on the estimated impact time or the estimated impact condition.

17. The method of claim 16, wherein moving the seat comprises moving the seat at a predetermined velocity for a predetermined distance.

18. The method of claim 17, wherein the seat velocity device comprises at least one of an airbag, a rocket, a pretensioner, a mass ejector, and a spring.

19. The method of claim 17, wherein moving the seat comprises moving the seat in a first direction, wherein the method further comprises engaging a motion device with the seat at the predetermined distance, and wherein the motion device provides an resisting force against movement of the seat in a second direction that is opposite from the first direction.

20. The method of claim 16, wherein estimating the impact condition includes estimating an impact direction of the impact event, and wherein moving the seat comprising moving the seat in a direction opposite from the impact direction.
